(19) United States
(12) Patent Application Publication
(10) Pub. No.: US 2007/0060154 A1
(43) Pub. Date: Mar. 15, 2007

(54) Method and device for transmitting user-selected data with a request for connection signal over a telecommunications network

(75) Inventors: Assaf Landschaft, Munich (DE); Gal Wohlstadter, Munich (DE); Gil Wohlstadter, Munich (DE)

Correspondence Address: HITT GAINES, PC;AGERE SYSTEMS INC., PO BOX 832570, RICHARDSON, TX, 75083, US

(73) Assignee: Agere Systems Inc., Allentown, PA (US)

(21) Appl. No.: 11/202,816

(22) Filed: Aug. 12, 2005

(51) Int. Cl. H04Q 7/20

(52) U.S. Cl. 455/450

(57) ABSTRACT

Provided is a method of establishing a communications connection that enables the party requesting such connection to send data regarding the connection together with the request signal connection. In one embodiment, the method includes (1) transmitting user-defined information data together with a request for connection signal from a first communications device to a second communications device; and (2) extracting the user-defined information data at the second communications device prior to establishing a connection with the first communications device.

### TECHNICAL FIELD OF THE INVENTION

The present invention is directed, in general, to telecommunications and, more specifically, to a method and device for transmitting user-selected data with a request for connection signal over a telecommunications network.

### BACKGROUND OF THE INVENTION

Callers using a cellular or mobile phone are currently unable to deliver information to the recipient of a call until the recipient establishes a connection. The only information currently conveyed is a ring signal (herein called a request for connection) informing the recipient that he or she is receiving a phone call together any network information made available by the phone system provider, such as caller identification. Frequently, a person making a call wants to convey additional information regarding the call in order to alert the recipient as to the nature of the call so he or she can decide whether on not to accept the call at that time. For example, if a caller wants to talk to a person, but does not want to interrupt his or her activity because the call is considered routine, the caller would like to be able to signal the recipient that the call is not urgent. For example, a wife may want to talk to her husband about a routine matter but does not want to interrupt if he is engaged in an important activity, such as would be the case if he were a salesman and was in the process of closing a sale with a customer. On the other hand, if the call is urgent or it is an emergency call, the caller would want this fact conveyed to the recipient so that he or she would be motivated to answer the call regardless of the activity in which he or she may be engaged. The reason for a call, its urgency, or other similar information useful to convey information to a called party can not currently be so conveyed until the called party actually accepts or answers the call.

Most mobile phones sold today already include a memory in which names, phone numbers and even associated pictures for a number of people can be stored. A communications network can currently be used to transmit a phone number, its associated name and/or even a picture to a recipient. Prior art also provides that a party receiving a call can designate a selected ring tone, a vibration, or even voice information to be associated with entries in the memory of a mobile phone, all of which can be used to identify a caller without having to look at the screen on the phone in order to identify a caller. However, these methods are static and can only be utilized for identifying a caller where the identification is already in the phone's memory. Information a caller may want to forward to a recipient, such as a reason for the call or the urgency of the call, can not now be provided. Such information can be useful for both business and personal reasons.

Accordingly, what is needed in the art is a way for a person making a call to provide supplementary information to a recipient of the call, before the call is answered.

### SUMMARY OF THE INVENTION

To address the above-discussed deficiencies in the prior art, the present invention provides a method of establishing a communications connection that enables the party requesting such connection to send data regarding the connection together with the request for connection signal. In one embodiment, the method includes (1) transmitting user-defined information data together with a request for connection signal from a first communications device to a second communications device, and (2) extracting the user-defined information data at the second communications device prior to establishing a connection with the first communications device.

Thus, the present invention advantageously permits a party seeking to establish a communications link with another party to send data together with the request for a connection or ring signal that can be reviewed before an interactive communication link is established. Such user-defined information data can include a number of different kinds and types of data. In one embodiment it can include, for example, a photograph of the person sending the request for connection signal so that the recipient can see who is making the request before he or she establishes the connection. Such an embodiment would be useful to a business person to see who is calling from a particular number, so that he or she will know how to respond to a particular call. For example, a person who is anticipating a call from a particular person can identify that particular person and answer his or her call while letting other calls go into a voice mailbox.

In one embodiment, the method provides for either the first communications device or the second communications device to be associated with a cell-based communications network supporting GSM and/or UMTS protocols. In another embodiment, the user-defined information data is selected from a plurality of data items stored in the first communications device. In still another embodiment, the user-defined information data is selected from a group consisting of a text, an image, an animation, a video sequence, an audio sequence, or an audio and video sequence.

A particularly useful embodiment of the invention provides for the user-defined information data to be an image or video sequence captured by a camera integrated in or attached to the first communications device. A beneficial embodiment of the invention provides for the request for connection to be further comprised of a parameter defining at least one type of user-defined information data. A complimentary embodiment provides for the second communications device to have an output for outputting the user-defined information based on this parameter.

In one embodiment, the invention provides for compressing and decompressing the user-defined information data by corresponding first and second compression algorithms associated with the first communications device and the second communications device, respectively. This embodiment permits more information to be transmitted with the ring or, based on the terminology used herein, request for connection signal while preserving valuable bandwidth.

The present invention also provides for a communications device that has, in one embodiment, (1) an input interface adapted for a user to provide user-defined information data, and (2) a transmitter for transmitting a request for connection signal over a communications network to another communications device where the request for connection signal includes the user-defined information data. An embodiment of this communications device provides for the user-defined information data to be selected from a group consisting of a text, an image, an animation, a video sequence, an audio sequence, or a video and audio sequence. In another embodiment, the communications device transmitter is adapted to transmit a request for connection signal that includes at least one type of the user-defined information data.

In another embodiment of the invention, the communications device's input interface is adapted to select at least one of the types of user-information data from a plurality of types stored in the communications device. In yet another embodiment, the communications device has a stored compression algorithm for compressing user-defined information data. In still yet another embodiment of the invention, the communications device is further comprising of a receiver adapted to extract the user-defined information data from the request for connection signal, and an output for outputting such data prior to a user responding to the request for connection signal. Another beneficial embodiment provides for the communications device to have a decompression algorithm stored therein for decompressing the extracted user-defined information data.

In one embodiment the invention provides for a communications device wherein the receiver is adapted to extract from the request for connection signal a parameter defining at least one type of user information data and to have the type of output determined based on this extracted parameter. An embodiment of the communications device provides for the output to be selected from a group consisting of a display, a speaker, a vibrator, a display together with a speaker, a display together with a speaker and a vibrator, a speaker and a vibrator, or a display and a vibrator.

An additional embodiment of the invention provides for a communications system that includes a first communications device and a second communications device connectable to a communications network, wherein (1) the first communications device includes an input interface adapted for a user to provide user-defined information data and a transmitter for transmitting a request for connection signal over the communications network to the second communications device, the request for connection signal including the user-defined information data; and (2) the second communications device includes a means for extracting the user-defined information data from the request for connection signal and a means for outputting the user-defined information data before a user of the second communications device responds to the request for connection signal.

The present invention also provides for a digital storage medium, such as a microchip, that permits implementation of the foregoing embodiments with respect to a first communications device. In one embodiment the invention provides for electronically readable control instructions for a first communications device, where the control instructions include (1) selection instructions adapted for a user to select user-defined information data within the first communications device; and transmission instructions adapted to transmit the user-defined information data together with a request for connection signal to a second communications device.

The present invention also provides for a digital storage medium that permits implementation of the foregoing embodiments with respect to a second communications device. In one embodiment, the invention provides for a digital storage medium, such as a microchip, that provides for electronically readable control instructions for a second communications device, where the control instructions include (1) extraction instructions for extracting user-defined information data from a request for connection signal received from a first communications device; and (2) output instructions for the second communications device to output the user-defined information data before a user of the second communications device responds to the request for connection signal.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of a cellular communications network utilizing an embodiment of the present invention;

FIG. 2 illustrates a block diagram of an embodiment of the present invention for communications between a cellular telephone and an ISDN telephone connected to a communications network by a landline;

FIGS. 3a and 3b illustrate output displays of user-defined information data received by a second communications device from a first communications device in accordance with one embodiment of the present invention; and

FIG. 4 illustrates a flow chart of a method of using one embodiment of the present invention.

### DETAILED DESCRIPTION

Before describing the FIGUREs, various aspects, embodiments and features of the present invention will be described. The invention presents a method for establishing a connection between a first communications device and a second communications, which connection can be via a cellular communications network, over a traditional landline network or a combination of the two. In one embodiment, the method includes the provision of user-defined information data, in particular an image, text or audio data, or any combination of the three, within the first communications device and transmitting a request for connection signal or ring signal from the first communications device to the second communications device via a communications network. The request for connection signal will also include the user-defined information data. The second communications device, upon receipt of the request for connection signal from the first communications device, will extract the user-defined information data from it and output it before the second communications device user responds to the request for connection signal. That is, the user of a telephone receiving a request for connection signal will be able to view, hear or otherwise receive the user-defined information data before he or she answers the phone.

This invention thereby enables a user making a phone call to include supplementary information in the request for connection signal that is transmitted to the phone of the called party. This supplementary information is output to the called user before he or she accepts the call. The transmitted user-defined information data can be textual, an image, an animation, a video sequence, a vibratory signal, or any combination of the foregoing. In this way more accurate information about a phone call can be sent by the person calling another party regarding the call or the party making the call to enable the person receiving the call to decide whether or not he or she should answer the call.

A particularly useful embodiment of the invention provides for the first and second communications devices to be used in connection with a cell-based network supporting at least GSM (Global System for Mobile Communications) and/or UMTS (Universal Mobile Telecommunications System) protocols. The invention, however, is not limited to GSM or UMTS, but also encompasses the utilization of a fixed network such as ISDN (Integrated Service Digital Network) or any other type of communications network now being used or that may hereafter be developed, as well as any devices used or to be used in or with such networks.

User-defined information data can be provided in a variety of forms and determined or selected in a number of different ways. For example, text can be input by a keypad; audio by a microphone associated with the communications device; a photograph or video sequence by a camera integrated in or associated with the communications device. The invention also provides for using data already stored in the first communications device, whereby the step of providing user-defined information data would simply consist of selecting at least one data item from a plurality of stored data items. Also, the user-defined information data to be transmitted need not be generated by the first communications device or stored therein, but can also be provided by an external means such as by a server. Using an external means to generate the user-defined information data would enable the use of data types that a communications device is not equipped to generate, such as, for example, animations.

A request for connection signal will include a parameter defining at least one data type, which data type will correspond to a selected type of user-defined information data. Of course the user-defined information data can also include information regarding other types of data, in which case the parameter will preferably define the different types of data and the order in which they are transmitted.

On the receiving side of a communications connection, the parameter defining the type of data is extracted and the means for outputting the received user-defined information data or other type of data is selected depending on the parameter defining the extracted data. For example, the data can be an image or text that will be output on a screen or display on the receiving communications device when the device indicates that it is receiving a request for connection signal. On the other hand, audio data will most probably be played as a ring tone on the receiving communications device.

When image or audio is transmitted as user-defined information data, the volume of data can be quite large. Therefore, one embodiment of the invention provides for the compression and decompression of user-defined information data by corresponding compression algorithms stored in the first and second communications devices respectively.

In order to prevent abusive use of the present invention, one embodiment of the invention gives the recipient of user-defined information data the option to designate callers or set of callers from whom he or she will accept or refuse to accept supplementary data such as user-defined information data accompanying a request for connection signal.

As described above, the user-defined information data preferably comprises a text, an image, an animation, a video sequence and/or an audio sequence, wherein the request for connection signal further includes a parameter defining the data type or types of user-defined information data. For user convenience, user-defined information data can also include data already stored in the communications device. Accordingly, one embodiment of the invention provides for the communications device interface with a user to be adapted to select a data item from a plurality of such data items stored in the communications device.

To receive user-defined information data or other supplementary data within a request for connection signal, the communications device also includes an extracting means for extracting such data from a received request for connection signal and an output means for outputting the extracted data. To output images, animations, texts and/or video or audio sequences, a communications device will generally have an output that includes a display and/or speaker. Of course, the output can also be a vibrator. To address different data types in one embodiment the extracting means is adapted to extract a parameter defining the data type from the received request for connection signal and the type of output to deliver the data is selected depending on such extracted parameter.

To enable a user of a communications device constructed in accordance with the present invention to select a number of parties from whom to accept user-defined information data or other supplementary data, one embodiment of the invention provides for the storage of at least one phone number, a means for detecting the phone number of a calling device and a means for comparing the detected phone number with the at least one phone number that is stored.

Although the present invention is particularly useful in the mobile communications environment, the utility of the invention is not so limited. The invention can be utilized with any type, of communications device, such as, without being limited to, a telephone, mobile phone, fax machine, personal digital assistant (PDA) or mobile digital assistant (MDA), as well as an appropriately equipped computer or other communications device whether now known or subsequently discovered.

In addition to the foregoing embodiments, a communications system also lies within the intended scope of the present invention. Such a system, in one embodiment, would include a first communications device, a second communications device and a communications network to which the two communications devices are connected or connectable. A communications system constructed in accordance with the present invention will provide for a first communications device that is adapted to send user-defined information data together with a request for connection signal over the communications network to the second communications device. The second communications device will be adapted to receive the user-defined information data within the request for connection signal in the manner described above.

To facilitate the implementation of the present invention, a digital storage medium such as a microchip is within the intended scope of the present invention. When associated with a communications device having the appropriate features, the storage medium will include electronically readable control instructions to enable the execution of any of the above described embodiments of the above present invention. When thus associated the electronically readable control instructions in the digital storage medium will provide for the communications device to be adapted to execute a process of providing user-defined information data, in particular image, text and/or audio data, within the first communications device in response to user input, and transmitting a request for connection signal to a second communications device. In another embodiment the invention provides for a digital storage medium that includes electronically readable control instructions adapted to execute a process of receiving a request for connection signal from a communications network, extracting user-defined information data or other supplementary data therefrom, and outputting such data to a user.

Turning initially to FIG. 1, illustrated is a block diagram of a cellular communications network 100 utilizing an embodiment of the present invention where the communications network 100 includes a first mobile phone 10 and a second mobile phone 10′ that are connectable by means of the communications network 100. The mobile phones 10, 10′ each have a user interface made up of a display 12, 12′ and a keypad 14, 14′. To capture images, the mobile phones 10, 10′ have cameras 16, 16′. The illustrated communications network 100 and the associated mobile phones 10, 10′ can, in one embodiment, be adapted to support either the GSM or the UMTS communications protocol.

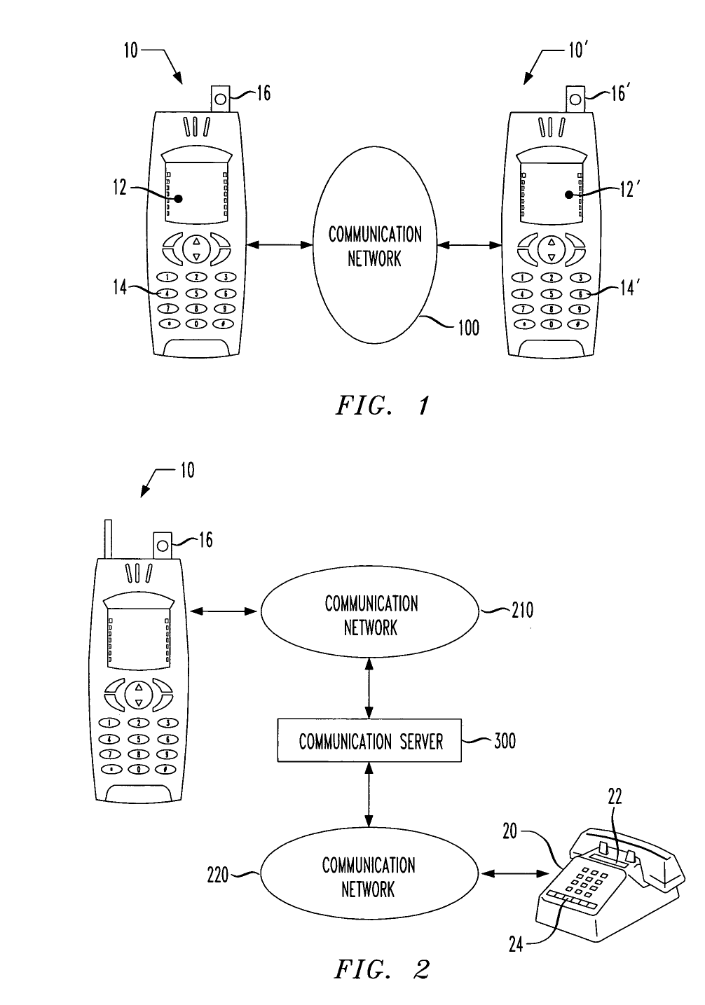

Turning now to FIG. 2, illustrated is a block diagram of an embodiment of the present invention for communications between a mobile or cellular telephone 10 and an ISDN telephone 20 connected to a communications network by a landline. Both the mobile telephone and the ISDN telephone have a user interface made up of a display 22 and a keypad 24. In this embodiment, the communications network that connects the mobile telephone 10 and the ISDN telephone 20 are made up of two communications networks 210, 220 and a communications server 300. The cellular communications network 210 in the illustrated embodiment supports GSM and has the mobile telephone 10 connected to it. The landline communications network 220 is a telephone network supporting ISDN and has the ISDN telephone 20 connected to it. For data conversion between the two communications networks 210, 220, a communications server 300 having a suitably integrated converter is provided.

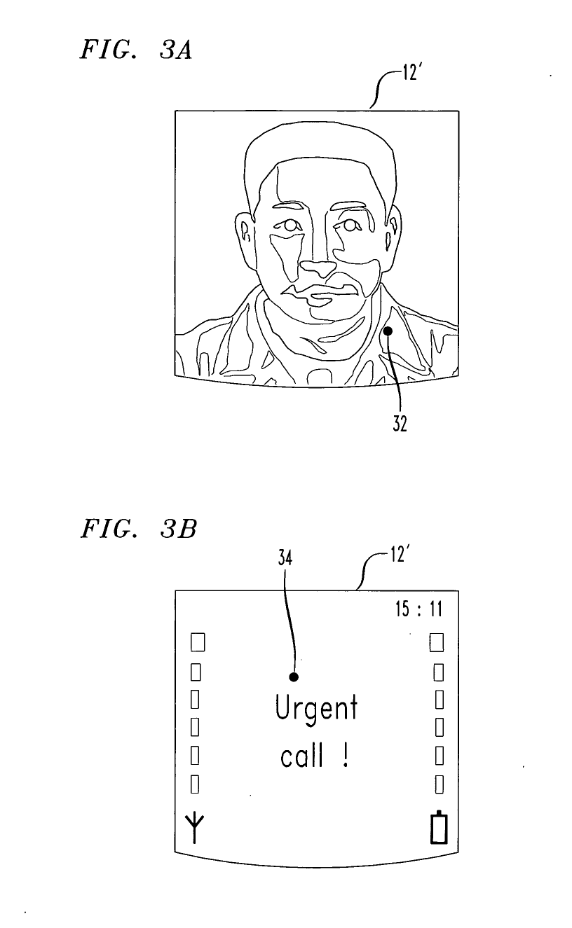

Now turning to FIGS. 3a and 3b, illustrated are output displays 12′ of user-defined information data received by a second communications device 10′ from a first communications device 10 in accordance with one embodiment of the present invention. The user of the first communications device 10 enters the number to be called using the keypad 12 of the first communications device 10. After providing the supplementary information to be sent to the second or receiving communications device 10′ together with the request for connection signal, the user presses the send key. The user-defined information or other supplementary information is selected by the user by entering text information using the keypad 12 or capturing an image using a camera 16. In another embodiment, an audio sequence can be recorded using a microphone (not shown) on the first communications device 10, which audio sequence can be sent together with the request for connection signal as supplementary information. In another embodiment of the invention, the supplementary information to be sent can be stored in the first communications device 10 and the user can designate the user-defined information to be sent by selecting from the available alternatives.

To select an appropriate output for the transmitted supplementary information, when received by the second communications device 10′, in one embodiment of the present invention the request for connection signal further includes a parameter defining the data type of transmitted supplementary information. This parameter can, for example, be added automatically when the user determines a type of user-defined information to be transmitted together with the request for connection signal. This parameter will designate the appropriate second communications device 10′ output used to deliver the transmitted supplementary data. For example, if a text signal is being transmitted, a parameter would be attached to it designating the output on the second communications device 10′ to be its display 12′. By the same token, if a voice message, tone or music selection is being transmitted; a parameter would be attached indicating that the speaker on the second communications device 10′ would be utilized as an output.

It is thus apparent that the present invention permits a caller to send an existing image, i.e. one that is already stored in the memory of the first communications device 10 or mobile telephone, or one taken with a camera 16 on the device immediately prior to transmission. The recipient will see the image 32 on the display 12, of his or her mobile telephone or second communications device 10′ at the same time the request for connection signal is received and the phone rings to alert the user to an incoming call. The user of the first communications device 10 could also create a short text message 34 to be displayed on the recipient's display 12′ at the same time the request for connection signal is being delivered. A caller could also send an audio file, already stored or directly recorded, which would played as for the recipient at the same time the request for connection signal is delivered.

The invention described herein is useful in both a business and personal context, which usefulness is readily apparent. In a business context, a user typically is interested in sending text or image data. When the recipient is screening calls because he or she is busy or in a meeting, it enables the called party to determine whether or not the call should be answered based on the transmitted information. The use of the invention to send audio data will typically is used by young people to develop original ways of alerting the party being called, such as, for example, by sending a distinctive ring tone signal that contains a message to the recipient.

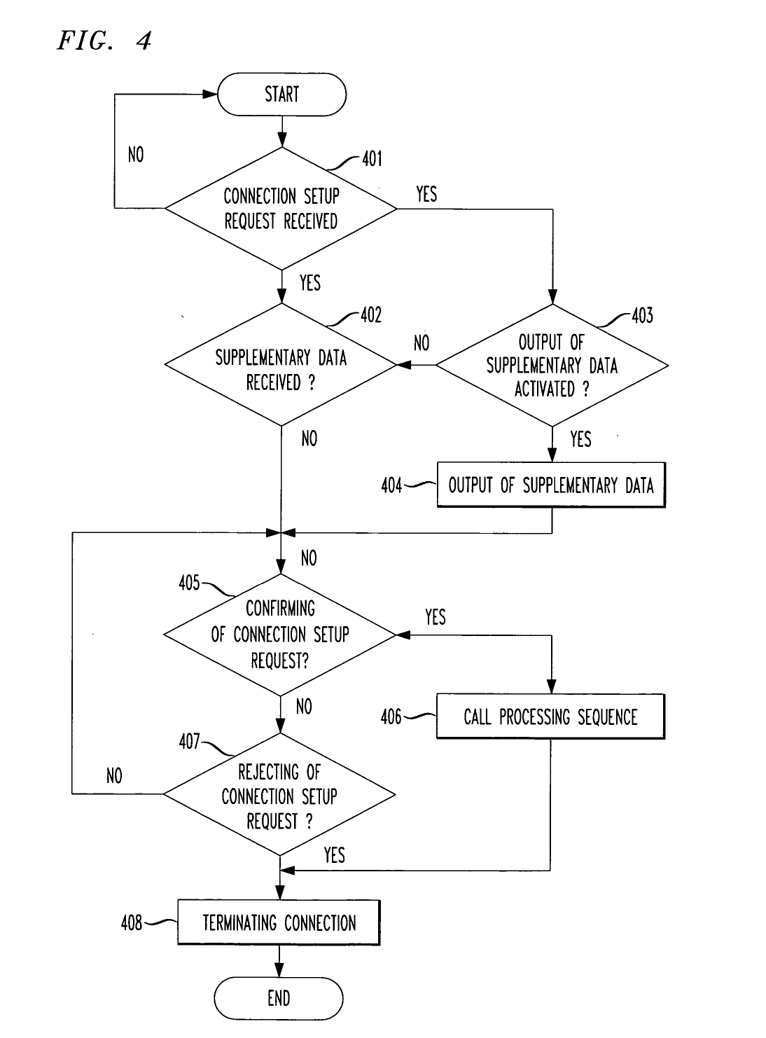

Turning now to FIG. 4, illustrated is a flow chart of a method of using one embodiment of the present invention. Illustrated is an example of the course of actions taken with respect to a mobile phone supporting GSM standards. The mobile phone repeatedly checks whether a request for connection signal is received 401. When a request for connection signal is received, the signal is checked to see whether the received request for connection signal contains supplementary information data 402. If supplementary information data is received and the output for supplementary data 403 is activated, the supplementary data is output 404 by the mobile phone on its display screen or speaker.

After the output of the supplementary data, or without output of data if no data is received or output is not activated, a repeated check is made on whether the request for connection signal is confirmed 405 or rejected 407 by a corresponding user input. Confirmation of the request for connection signal is followed by a normal call processing sequence 406. After call processing or when the request for connection signal is rejected, the connection is terminated 408.

Although the present invention has been described in detail, those skilled in the art should understand that they can make various changes, substitutions and alterations herein without departing from the spirit and scope of the invention in its broadest form.

What is claimed is:

1. A method of establishing a communications connection, comprising:
transmitting user-defined information data together with a request for connection signal from said first communications device to said second communications device; and
extracting said user-defined information data at said second communications device prior to establishing a connection with said first communications device.

2. The method as recited in claim 1 wherein at least one of said first communications device or said second communications device is associated with a cell-based communications network supporting GSM and/or UMTS protocols.

3. The method as recited in claim 1 wherein said user-defined information data is selected from a plurality of data items stored in said first communications device.

4. The method as recited in claim 1 wherein said user-defined information data is selected from a group consisting of:
a text;
an image;
an animation;
a video sequence;
an audio sequence;
an audio and video sequence.

5. The method as recited in claim 1 wherein said user-defined information data is an image or a video sequence captured by a camera integrated in or attached to said first communications device.

6. The method as recited in claim 1 wherein said request for connection is further comprised of a parameter defining at least one type of said user-defined information data.

7. The method as recited in claim 6 further comprising said second communications device having an output for outputting said user-defined information based on said parameter.

8. The method as recited in claim 1 further comprising compressing and decompressing said user-defined information data by corresponding first and second compression algorithms associated with said first communications device and said second communications device, respectively.

9. A communications device, comprising:
an input interface adapted for a user to provide user-defined information data, and
a transmitter for transmitting a request for connection signal over a communications network to another communications device, said request for connection signal including said user-defined information data.

10. A communications device as recited in claim 9 wherein said user-defined information data is selected from a group consisting of:
a text;
an image;
an animation;
a video sequence;
an audio sequence; or
a video and audio sequence.

11. A communications device as recited in claim 10 wherein said transmitter is adapted to transmit a request for connection signal that includes at least one type of said user-defined information data.

12. A communications device as recited in claim 9 wherein said input interface is adapted to select at least one of said user-information data from a plurality of types of said user information data stored in said communications device.

13. A communications device as recited in claim 9 further comprising a compression algorithm stored in said communications device for compressing said user-defined information data.

14. A communications device as recited in claim 9 further comprising:
a receiver adapted to extract said user-defined information data from said request for connection signal; and
an output for outputting said user-defined information data prior to a user responding to said request for connection signal.

15. A communications device as recited in claim 14 further comprising a decompression algorithm stored in said communications device for decompressing said user-defined information data extracted from said request for connection signal.

16. A communications device as recited in claim 14 wherein said:
receiver is further adapted to extract a parameter from said request for connection signal, said parameter defining at least one type of user information data; and
a type of said output is determined based on said extracted parameter.

17. A communications device as recited in claim 14 wherein said output is selected from a group consisting of:
a display;
a speaker;
a vibrator;
a display and a speaker;
a display, a speaker and a vibrator;
a speaker and a vibrator; or
a display and a vibrator.

18. A communications device, comprising
a means for extracting data from a request for connection signal received from an associated communications device, said data defined by the user of said associated communications device; and
an output for outputting said data before a user of said communications device responds to said request for connection signal.

19. A communications device as recited in claim 18 further comprising an algorithm stored in said communications device for decompressing said data.

20. A communications device as recited in claim 18 wherein:
said extracting means is adapted to extract a parameter from said request for connection signal, said parameter defining at least one type of data type; and
said output is selectable depending on said parameter.

21. A communications device as recited in claim 18 wherein said output is selected from a group consisting of:
a display;
a speaker;
a vibrator;
a display and a speaker;
a display, a speaker and a vibrator;
a speaker and a vibrator; or
a display and a vibrator.

22. A communications system, comprising:
a first communications device and a second communications device connectable to a communications network, wherein:
said first communications device includes an input interface adapted for a user to provide user-defined information data and a transmitter for transmitting a request for connection signal over said communications network to said second communications device, said request for connection signal including said user-defined information data; and.
said second communications device includes a
means for extracting said user-defined information data from said request for connection signal and a means for outputting said user-defined information data before a user of said second communications device responds to said request for connection signal.

23. A digital storage medium, comprising:
electronically readable control instructions for a first communications device, said control instructions including:
selection instructions adapted for a user to select user-defined information data within said first communications device; and
transmission instructions adapted to transmit said user-defined information data together with a request for connection signal to a second communications device.

24. A digital storage medium, comprising;
electronically readable control instructions for a second communications device, said control instructions including:
extraction instructions for extracting user-defined information data from a request for connection signal received from a first communications device; and
output instructions for said second communications device to output said user-defined information data before a user of said second communications device responds to said request for connection signal.
